(19) United States
(12) Patent Application Publication
(10) Pub. No.: US 2026/0024832 A1
(43) Pub. Date: Jan. 22, 2026

(54) A RECYCLING METHOD FOR RECOVERY OF VALUABLE METAL ELEMENTS FROM MATERIALS CONTAMINATED WITH FLUORINE

(71) Applicant: GELION TECHNOLOGIES PTY LTD, North Sydney, New South Wales (AU)

(72) Inventors: George Platt, Royston (GB); Julia Vallejo Navarret, Sonning Common (GB); Koen Vandaele, Sonning Common (GB)

(21) Appl. No.: 18/997,994

(22) PCT Filed: Jul. 25, 2023
(86) PCT No.: PCT/AU2023/050675

§ 371 Date: Jan. 23, 2025

(30) Foreign Application Priority Data
Jul. 25, 2022 (GB) 2210850.0

(51) Int. Cl. H01M 10/54; C22B 3/24; C22B 7/00; C22B 26/12

(52) U.S. Cl. CPC H01M 10/54; C22B 3/24; C22B 7/007; C22B 26/12

(57) ABSTRACT

A method of recycling one or more valuable metal elements from a solid source material comprising the one or more valuable metal elements and fluorine, the method comprising: forming an acidic aqueous recycling feed by acid leaching the source material, or derivative thereof, the acidic aqueous recycling feed comprising the one or more valuable metal elements; and recovering the one or more valuable metal elements from the acidic aqueous recycling feed via one or more further process steps selected from solvent extraction, solid phase extraction, electrochemical extraction, and precipitation processes, wherein the fluorine is extracted prior to recovery of the one or more valuable metal elements from the acidic aqueous recycling feed.

### RELATED APPLICATION

This application claims priority from Great Britain Patent Application No. GB2210850.0, filed on 25 Jul. 2022, the entire contents of which are incorporated herein by reference.

### FIELD

The present invention relates to a recycling method for recovery of valuable metal elements from materials contaminated with fluorine (which may be in the form of one or more fluorine containing compounds). The method may be applied for recycling of waste battery materials, although it is also envisaged that the methodology may be applied to other source materials comprising valuable metal elements and fluorine species. However, it will be appreciated that the invention is not limited to this particular field of use.

### BACKGROUND

Lithium-ion batteries are now ubiquitous in modern society, finding use not only in small, portable devices such as mobile phones and laptop computers but also increasingly in electric vehicles. A lithium-ion battery generally includes a graphite anode separated from a cathode by an electrolyte, through which lithium ions flow during charging and discharging cycles. The cathode in a lithium-ion battery may include a lithium transition metal oxide, for example a lithium nickel oxide, lithium cobalt oxide or lithium manganese oxide.

Although lithium-ion and other modern rechargeable batteries offer a promising low-carbon energy source for the future, one concern is that the metals required for their manufacture, such as lithium, nickel, cobalt and/or manganese, often command high prices due to their limited availability and difficulty of extraction from natural sources. There is therefore a need for methods which recycle or purify the metals present within batteries, such as the metals present within the cathodes of batteries, to provide materials which may be used as feedstock in battery manufacture.

During battery material recycling processes, an effluent solution is generated containing valuable metal elements such as cobalt and nickel which could be used in the manufacture of new battery materials if they could be extracted in sufficient purity. Such solutions may be generated by leaching from waste battery materials including so-called “black mass”, a mixture of valuable metals alongside unwanted impurities. Such solutions therefore include other less desirable or unwanted metal elements or impurities. The solutions may contain a mixture of metal elements and it is often desirable to extract only one, or a limited number, of these metal elements.

One problem with processing such waste battery materials to recycle valuable metal elements is that the solid source materials generally comprise one or more fluorine containing species including HF, which may be present in the waste material itself or generated from other fluorine containing species during processing of the waste material. For example, LiPF₆ present in end-of-life batteries can hydrolyse during processing to produce a number of decomposition products including HF. The hydrolysis mechanism of LiPF₆ may include one or more of the following steps:

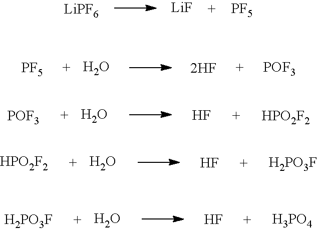

Considering the serious environmental health and safety risks and material compatibility implications related to HF, it is desirable to remove substantially all fluorine containing species (i.e., potentially HF liberating species) present in waste battery material before it is further processed to recover valuable metal species. The species that need to be removed from black mass include, for example, LiPF₆ and its decomposition products as indicated above.

It is an aim of the present specification to at least partially address this problem, or at least provide a useful alternative.

It is an object of the present invention to overcome or ameliorate one or more of the disadvantages of the prior art, or at least provide a useful alternative.

### SUMMARY OF INVENTION

The present specification provides a method of recycling one or more valuable metal elements from a solid source material comprising the one or more valuable metal elements and fluorine, the method comprising:
forming an acidic aqueous recycling feed by acid leaching the source material, or derivative thereof, the acidic aqueous recycling feed comprising the one or more valuable metal elements; and
recovering the one or more valuable metal elements from the acidic aqueous recycling feed via one or more further process steps selected from solvent extraction, solid phase extraction, electrochemical extraction, and precipitation processes,
wherein the fluorine is extracted prior to recovery of the one or more valuable metal elements from the acidic aqueous recycling feed by one or more of the following processes:
(a) leaching the source material, or a derivative thereof, with a solvent to remove fluorine from the source material into the solvent prior to forming the acidic aqueous recycling feed, adsorbing the fluorine in the solvent onto an adsorbent, and recycling the solvent to perform further leaching of fluorine from source material;
(b) leaching the source material, or a derivative thereof, with a solvent to remove at least one of the valuable metal elements from the source material into the solvent prior to forming the acidic aqueous recycling feed, adsorbing fluorine in the solvent onto an adsorbent, and further processing the solvent to recover said at least one of the valuable metal elements; and
(c) after forming the acidic aqueous recycling feed, adsorbing fluorine in the acidic aqueous recycling onto an adsorbent prior to recovering the one or more valuable metal elements from the acidic aqueous recycling feed.

The method may utilize one, more, or all of the options (a) to (c) in order to extract fluorine prior to recovering the one or more valuable metal elements from the acidic aqueous recycling feed. In relation to the above, the fluorine in the source material may be in the form of one or more fluorine containing compounds, e.g., metallic fluorides, HF, organic compounds (e.g., PVDF), and/or phosphor-fluorine compounds such as PF₆ compounds and decomposition moieties thereof. Furthermore, the solvents used in options (a) and (b) may be simple solvating solutions or reactant solutions, i.e., a solution which comprises one or more species which react with the fluorine containing compounds in the source material in order to leach fluorine species into the solution. Fluorine leached into the solvents may be in the form of one or more fluorine containing species. Adsorption of fluorine by the adsorbent may be via physical adsorption or by chemical reaction. The adsorbent is preferably a glass material such as a barium-silicate glass. Furthermore, it may be noted that in options (a) and (b), recycling of the solvent to perform further leaching of the source material could be a re-leach of the source material if required or a fresh leach of a new source material feed.

Fluorine species including HF can be removed from source materials, such as battery waste materials, by multiple wash steps. However, this yields a large quantity of dilute fluoride salt effluent (e.g., 3-5 litres of water per 100 g black mass) containing electrolyte, LiF salt, and LiPF₆ among other degradation products formed, for example, during the lifetime of a battery. This effluent is considered a major technical and economic risk to the recycling process.

The present specification addresses this issue by providing a method which enables leaching a source material, or a derivative thereof, with a solvent to remove fluorine from the source material into the solvent. The solvent is then treated to adsorb the fluorine in the solvent onto an adsorbent (e.g., a glass material such as a barium-silicate glass) such that the solvent can be recycled to perform further leaching of fluorine from source material. The source material can then undergo further processing to extract valuable metal elements such as nickel, cobalt, lithium, and/or manganese from battery waste materials or platinum group metals (PGMs) from PGM based catalyst waste materials while avoiding the formation of HF and associated health and safety issues. This method thus provides a more sustainable and environmentally friendly approach to recycling of materials which comprise both fluorine and valuable metals while also improving safety of downstream processing steps by removing the fluorine upfront in the process using a method which does not produce a large quantity of waste effluent and which does not unduly introduce additional impurities into the downstream processes for extracting and purifying valuable metal elements.

Alternatively, or additionally, to providing a dedicate leaching process (option (a)) for removing fluorine species from the source material, the source material can be processed to extract metal species into solution and then those solutions can be treated to remove fluorine from the solutions prior to further processing to recover the metal species. This may include a preliminary leach (option (b)) to extract at least one valuable metal from the source material, or a derivative thereof, into a solvent prior to forming the acidic aqueous recycling feed (e.g., lithium which may be leached using an organic acid such as formic acid). In this case, after removing fluorine the solvent can be processed to recover the at least one valuable metal from the solvent prior to recycling and reusing the solvent in the method. Additionally, or alternatively, after forming the acidic aqueous recycling feed this may be treated to extract fluorine (option (c)) prior to further processing to recover valuable metal species.

The present specification also provides a method of removing fluorine from a process or waste stream comprising fluorine (e.g., in the form of one or more fluorine containing species) in a solvent, the method comprising contacting the process or waste stream with a glass adsorbent (e.g., a barium silicate glass) to adsorb the fluorine (e.g., by physical adsorption or chemical reaction). In this case, the process or waste stream comprising fluorine species in a solvent may be formed by extracting the fluorine species into the solvent from a solid phase material comprising fluorine (e.g., in the form of one or more fluorine containing compounds). The solid phase material may be a waste battery material or a mixture of waste battery materials (e.g., black mass).

For example, there may be provided a method of removing fluorine moieties from a solid phase mixture of waste battery materials by applying a process comprising: (a) extraction of F from the solid phase waste battery materials into solution; and (b) adsorption or reaction to remove a majority of the solution phase F into/onto a solid phase material comprising or consisting of a glass material (e.g., a barium-silicate glass).

The extraction of fluorine species from the solid phase material into the solvent/solution may be achieved by leaching with a simple solvating solvent or may be achieved by leaching with a reactant solution comprising a solvent including one or more reactive species/moieties which react with fluorine containing compounds in the solid phase material in order to extract fluorine containing species into solution.

Adsorption of fluorine species from solution can then be achieved by reaction with the solid phase glass to immobilise the F in a solid removable form. By chemically binding fluorine ions to the glass, an effectively permanent binding can be achieved such that the F-loaded solid glass material can be subsequently removed and safely disposed of without risk of HF formation. As such, extraction is carried out using a solvent or reactant solution followed by adsorption which is by reaction with solid phase glass to immobilise the F in a solid removable form.

### BRIEF DESCRIPTION OF THE DRAWINGS

For a better understanding of the present invention and to show how the same may be carried into effect, certain embodiments of the present invention will now be described by way of example only with reference to the accompanying drawings, in which:

FIG. 1 shows an example of a battery materials recycling process;

FIG. 2 shows another example of a battery materials recycling process;

FIG. 3 shows a method according to the present specification which may be integrated into a process such as that illustrated in FIG. 1 or 2;

FIG. 4 shows another method according to the present specification which may be integrated into a process such as that illustrated in FIG. 1 or 2;

FIG. 5 shows another method according to the present specification which may be integrated into a process such as that illustrated in FIG. 1 or 2; and

FIG. 6 shows another method according to the present specification which may be integrated into a process such as that illustrated in FIG. 1 or 2.

### DETAILED DESCRIPTION

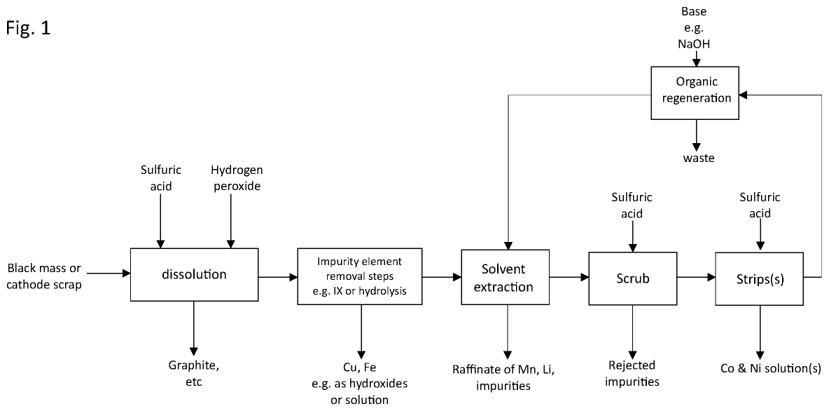

FIG. 1 shows an example of a battery materials recycling process. The starting material is cathode scrap or so-called “black-mass” which typically comprises Li, Ni, Co, Mn and impurities including Cu and Fe. The material is subjected to an acid dissolution or leaching step to obtain an acidic aqueous recycling feed comprising the constituent metal species in solution. The acidic aqueous recycling feed also comprises impurities such as Fe which can interfere with subsequent extraction steps. As such, it is desirable to selectively remove such impurities prior to further processing of the acidic aqueous recycling feed. An organic solvent extraction step can then be applied to separate Co and Ni (in the organic phase) from Mn and Li. An acid scrub can further be applied to the organic phase to remove any remaining impurities prior to stripping of the Co and Ni into aqueous Co and Ni solutions. The organic phase can be regenerated and recycled for use in further extraction of Co and Ni. The method of FIG. 1 enables Co and Ni to be separated from the cathode black mass material. However, further process steps are required if separation of Li and Mn from each other is to be achieved.

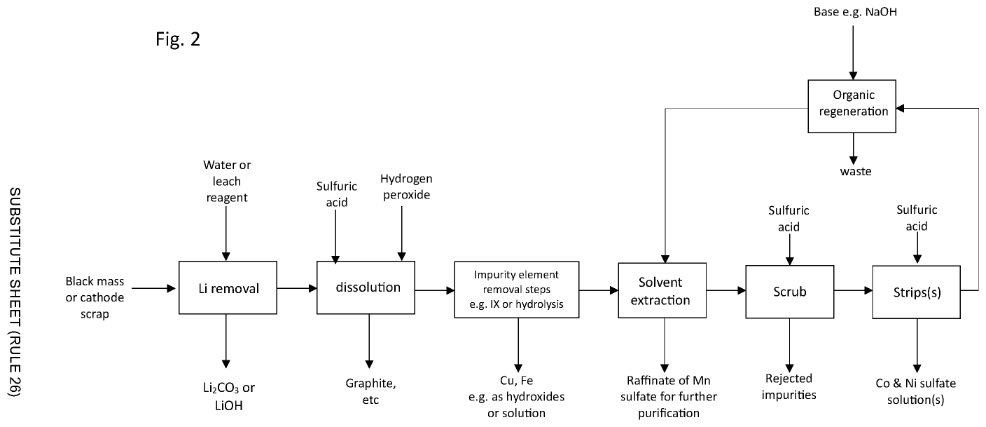

FIG. 2 shows another example of a battery materials recycling process. Again, the starting material is cathode scrap or so-called “black-mass” which typically comprises Li, Ni, Co, Mn and impurities including Cu and Fe. However, in this example, the lithium is removed first by treatment with a suitable solvent (e.g., an organic acid such as formic acid) which dissolves Li but not the other metal species. The remaining material is subjected to an acid dissolution or leaching step to obtain an acidic aqueous recycling feed comprising the remaining constituent metal species in solution. Again, the acidic aqueous recycling feed also comprises impurities such as Fe which can interfere with subsequent extraction steps. As such, it is desirable to selectively remove such impurities prior to further processing of the acidic aqueous recycling feed. An organic solvent extraction step can then be applied to separate Co and Ni (in the organic phase) from Mn. An acid scrub can further be applied to the organic phase to remove any remaining impurities prior to stripping of the Co and Ni into aqueous Co and Ni solutions. The organic phase can be regenerated and recycled for use in further extraction of Co and Ni. The method of FIG. 2 is advantageous in that it enables an efficient 4-way separation of Li, Mn, Co, and Ni to be achieved.

For either of the battery materials recycling processes described with reference to FIGS. 1 and 2, a problem arises due to the presence of fluorine containing species in the starting black mass material generating HF during materials processing. Since HF is a serious environmental health and safety risk, it is desirable to remove the fluorine species from the black mass material prior to implementing processing steps to recover valuable metal elements from the material. For example, HF is highly reactive and can corrode materials of construction (adding cost by necessitating more exotic materials choice) and degrade separation media (e.g. silica ion exchange media) causing more frequent replacement of chemicals. As described in the summary section, the present specification provides a method of recycling one or more valuable metal elements from a solid source material comprising the one or more valuable metal elements and fluorine, the method comprising:
forming an acidic aqueous recycling feed by acid leaching the source material, or derivative thereof, the acidic aqueous recycling feed comprising the one or more valuable metal elements; and
recovering the one or more valuable metal elements from the acidic aqueous recycling feed via one or more further process steps selected from solvent extraction, solid phase extraction, electrochemical extraction, and precipitation processes,
wherein the fluorine is extracted prior to recovery of the one or more valuable metal elements from the acidic aqueous recycling feed by one or more of the following processes:
(a) leaching the source material, or a derivative thereof, with a solvent to remove fluorine from the source material into the solvent prior to forming the acidic aqueous recycling feed, adsorbing the fluorine in the solvent onto an adsorbent, and recycling the solvent to perform further leaching of fluorine from source material;
(b) leaching the source material, or a derivative thereof, with a solvent to remove at least one of the valuable metal elements from the source material into the solvent prior to forming the acidic aqueous recycling feed, adsorbing fluorine in the solvent onto an adsorbent, and further processing the solvent to recover said at least one of the valuable metal elements; and
(c) after forming the acidic aqueous recycling feed, adsorbing fluorine in the acidic aqueous recycling onto an adsorbent prior to recovering the one or more valuable metal elements from the acidic aqueous recycling feed.

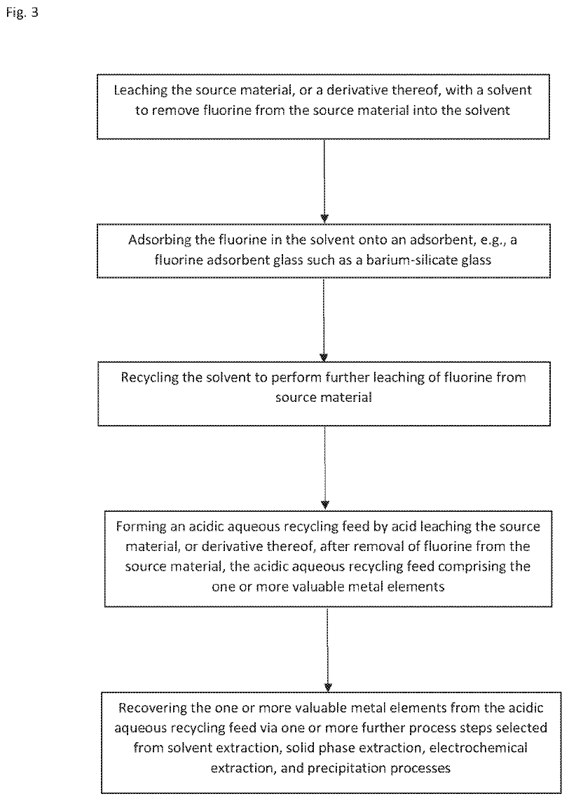

The method may utilize one, more, or all of the options (a) to (c) in order to extract fluorine prior to recovering the one or more valuable metal elements from the acidic aqueous recycling feed. An example following option (a) is illustrated in FIG. 3, which provides a method of recycling one or more valuable metal elements from a solid source material comprising the one or more valuable metal elements and fluorine, the method comprising:
leaching the source material, or a derivative thereof (e.g., the source material may be thermally treated prior to the leaching such that the leaching is performed on a thermally treated derivative of the original source material), with a solvent to remove fluorine from the source material into the solvent;
adsorbing the fluorine in the solvent onto an adsorbent;
recycling the solvent to perform further leaching of fluorine from source material;
forming an acidic aqueous recycling feed by acid leaching the source material, or derivative thereof (noting that one or more metal species may be leached out from the source material prior to forming the acidic aqueous recycling feed, e.g., Ni/Cu removal from a PGM source material or Li removal from a battery cathode source material), after removal of fluorine from the source material, the acidic aqueous recycling feed comprising the one or more valuable metal elements; and
recovering the one or more valuable metal elements from the acidic aqueous recycling feed via one or more further process steps selected from solvent extraction, solid phase extraction, electrochemical extraction, and precipitation processes.

The solvent used to leach fluorine from the source material, or a derivative thereof, optionally comprises one or more of an aqueous solvent, an acidic solvent, a basic solvent (e.g., a polar solvent comprising an alkaline earth hydroxide), and an organic solvent.

The adsorbent is optionally a silica-based adsorbent, a metal-based adsorbent, and/or an ion exchange resin that can adsorb/react with F. Such ion exchange resins include, for example, zirconium or aluminium pre-loaded chelating resins with amino-methyl phosphonic acid functionality, a strongly basic anion exchange resin containing quaternary ammonium functional groups, an iminodiacetic acid functionalized cation exchange resin pre-loaded with metal ions (such as Fe³⁺, Al³⁺, Ce³⁺, and/or La³⁺), or a cryptand ligand. Preferably the adsorbent is a silica-based adsorbent, for example a glass material such as a barium-silicate glass material which can be provided in glass powder form. The fluorine containing wash solution can be passed through a packed column or bed of such an adsorbent to remove fluorine. The adsorbent can periodically be replaced and/or treated to remove the fluorine and re-generate the adsorbent for re-use.

The source material is advantageously in the form of a powder, e.g., a powder which has a maximum participle size of less than 1 mm. Such a powdered material can be formed by milling the source material prior to applying the fluorine washing treatment. Fluorine is more readily removed from such a small particle size source material by the treatment as described herein when compared with a source material which comprises larger pieces/chunks of solid material where fluorine species can be trapped in the interior of the material.

The source material may be a battery material such as a black mass battery waste material derived from a battery cathode material comprising lithium and at least one of nickel, cobalt and/or manganese. In this case, after treating the material to remove fluorine, lithium can be leached or washed from the substantially fluorine-free source material prior to forming the acidic aqueous recycling feed comprising other valuable metal elements to be recovered. As such, the initial treatment of the battery cathode material may comprise both removal of fluorine and removal of lithium prior to forming the acidic aqueous recycling feed comprising other valuable metal elements to be recovered. In the event that the solvent which is being recycled contains lithium, this lithium can be removed from the recycled solvent, e.g., by precipitation which can be achieved, for example, by addition of Na₂CO₃ to form Li₂CO₃.

Alternatively, the source material may be another type of material which comprises valuable metal elements which are to be recycled and which also comprises one or more fluorine species, e.g., a material comprising one or more platinum group metals and fluorine, e.g., a waste material derived from a catalyst coated membrane for a fuel cell or water electrolyser.

In either case, the acidic aqueous recycling feed can be formed using a mineral acid such as sulphuric acid or hydrochloric acid. A key feature of embodiments of the present invention is that the acidic aqueous recycling feed contains substantially no fluorine. By “substantially no fluorine”, we mean a fluorine content of less than 1.0 wt %, 0.1 wt %, 0.05 wt %, or 0.01 wt %.

It may be noted that in the water treatment industry, fluoride is commonly removed by membrane and/or surface assimilation techniques using alumina or other metal-based adsorbents. However, the use of alumina and other metal-based adsorbents (e.g., calcium oxide or hydroxide) are better avoided in metal recycling processes, such as battery materials recycling, as they can result in further complications downstream in the metal purification processes (e.g., by contaminating with other metal elements). This is problematic if it is desired to recycle and reuse the wash effluent as described herein as this can lead to contamination of the source material with components of the adsorbent used to remove fluorine from the wash effluent. Accordingly, the use of a silica-based adsorbent capable of binding HF to the surface, without dissolution of Si—F, is well suited for the purpose. Preferred examples of the present specification apply a glass material, such as a barium-silicate glass, which is capable of removing HF as a stationary phase column or bed to clean eluent of solution used to wash the source material (e.g., battery waste material) being recycled. This allows the eluent to be reused in extracting more fluoride from the source material repeatedly without undue contamination of the source material leading to problems in downstream processing to extract and purify valuable metal elements. Once a sufficient quantity of fluoride removal is achieved, the source material can be moved downstream for further recycling without the major environmental health and safety concerns of fluoride, without having generated a large quantity of waste effluent, and without having contaminated the source material with additional impurities which would be problematic to the extraction and purification of valuable metal elements from the source material.

Examples of the present specification thus preferably use a glass material capable of removing HF during the recycling process of lithium-ion batteries. Following the extraction of HF from the battery material being recycled with solvent washing, the HF containing solution is passed over a stationary phase column or bed containing the glass material in powder or bead form to allow the recirculation of the wash liquor. The removal of HF from the recycling process allows safer handling of the source material and the eluent.

An example of a glass material capable of removing HF is the HF scavenging glass G018-405 manufactured by SCHOTT AG. This glass is an example of a material capable of irreversibly binding HF. The material has previously been used as a HF scavenger within active lithium-ion batteries. The present specification proposes to use this material, or an alternative thereof, to treat fluorine containing effluent in a battery materials recycling process. The glass has the further advantage that it is capable of binding HF to the stationary phase without releasing fluorosilicates into solution which is highly beneficial in preventing complications to the recycling process where different elements are being separated.

The process as described herein is thus capable of removing HF in a battery material recycling process using solvent extraction to remove HF at early stages of the recycling process. The glass material then cleans the eluent which allows recirculation of the solvent for reuse. Removal of fluoride by a glass-based stationary phase enables this process to be achieved without causing complications in the downstream process by introduction of undesired species. Furthermore, by enabling recycling of the eluent, the amount of eluent waste generated by such process is minimised thus minimising the environmental impact of the process.

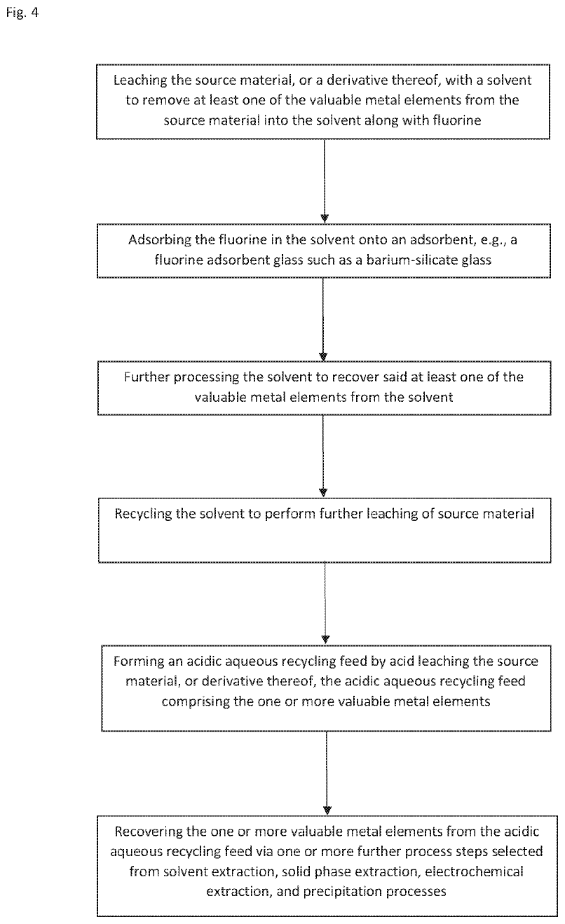

Another example of a process according to the present specification is illustrated in FIG. 4. In this case, the leaching of fluorine is combined with a preliminary leach to extract at least one of the valuable metal elements prior to forming the acidic aqueous recycling feed. This process may be integrated into the method illustrated in FIG. 2 in which the lithium is leached/washed from the source material up front in the process. The method thus comprises leaching the source material, or a derivative thereof, with a solvent to remove at least one of the valuable metal elements (e.g. lithium) from the source material into the solvent along with fluorine. The fluorine in the solvent can then be adsorbed onto an adsorbent, e.g., a fluorine adsorbent glass such as a barium-silicate glass prior to further processing of the solvent to recover the valuable metal element(s) from the solvent. This may be via solvent extraction, solid phase extraction, electrochemical extraction, and/or precipitation processes. The solvent can then be recycled to perform further leaching of source material. Once the preliminary leach has been performed, e.g., to extract lithium, an acidic aqueous recycling feed can be generated by acid leaching the source material, or derivative thereof, the acidic aqueous recycling feed comprising the remaining valuable metal elements which can be recovered from the acidic aqueous recycling feed via one or more further process steps selected from solvent extraction, solid phase extraction, electrochemical extraction, and precipitation processes.

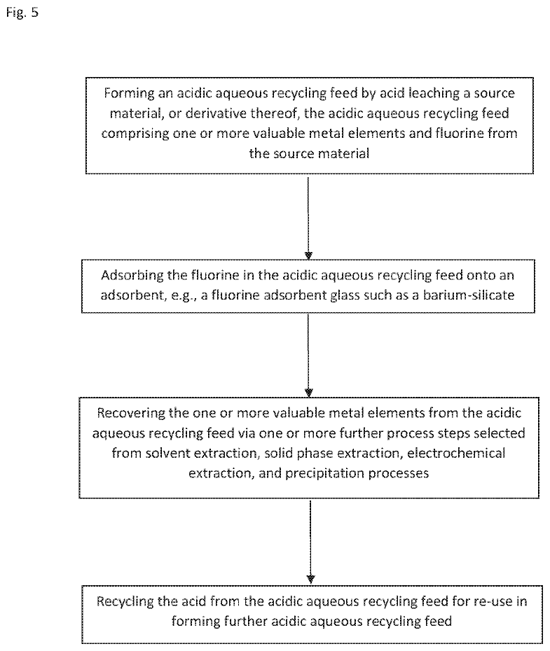

Another example of a process according to the present specification is illustrated in FIG. 5. In this case, fluorine is removed after forming the acidic aqueous recycling feed. The process thus comprises forming an acidic aqueous recycling feed by acid leaching a source material, or derivative thereof, the acidic aqueous recycling feed comprising one or more valuable metal elements and fluorine from the source material. Subsequently, the fluorine in the acidic aqueous recycling feed is adsorbed onto an adsorbent, e.g., a fluorine adsorbent glass such as a barium-silicate or a F specific ion exchange resin. The one or more valuable metal elements can then be recovered from the acidic aqueous recycling feed via one or more further process steps selected from solvent extraction, solid phase extraction, electrochemical extraction, and precipitation processes. Finally, the acid from the acidic aqueous recycling feed can be recycled for re-use in forming further acidic aqueous recycling feed.

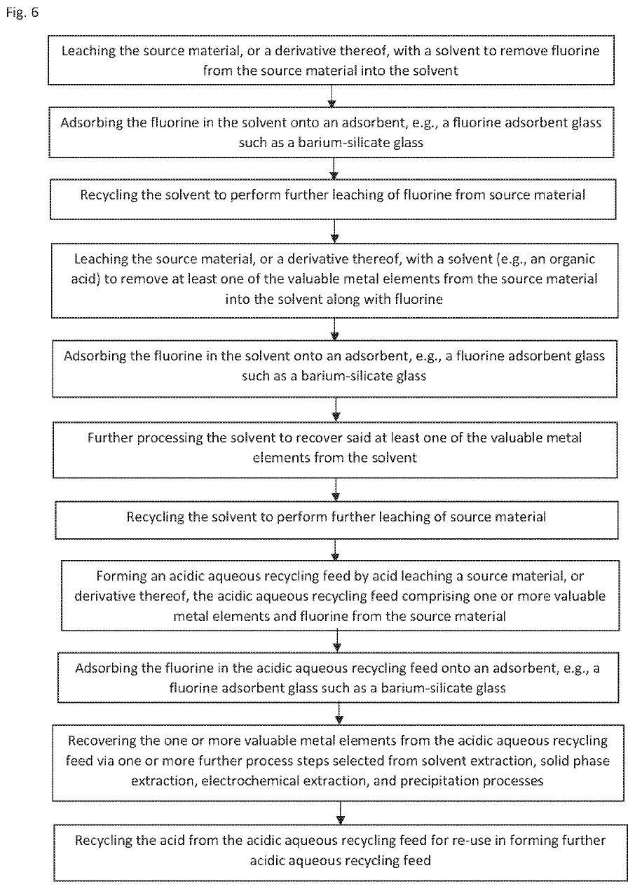

The methods illustrated in FIGS. 3 to 5 can be combined in any combination. For example, a dedicated fluorine leach can be performed on the source material with the fluorine being adsorbed from the leach effluent as illustrated in FIG. 3. This can be followed by a targeted leach to extract at least one of the valuable metal elements (e.g., lithium). Any fluorine extracted into the leach solution during this step can also be adsorbed prior to recovery of the valuable metal elements as illustrated in FIG. 4. Finally, the remaining valuable metal elements in the source material can be dissolved in a mineral acid and any fluorine extracted into the mineral acid can also be adsorbed prior to recovery of the valuable metal elements as illustrated in FIG. 5. FIG. 6 illustrates such a combined process in which fluorine is adsorbed from each of three process streams according to all of options (a) to (c) as previously defined. That said, it should also be noted that examples of the present specification may only utilize two of the three possible options described herein. For example, the dedicated fluorine leach may be excluded such that fluorine is intentionally leached into the process streams of options (b) and (c) along with valuable metal elements and then the fluorine is removed up-front in those process streams prior to recovery of the valuable metal elements.

While the invention has been described above in relation to recycling of battery waste materials, it is also envisaged that the teachings of the present specification can be utilized in other applications which generate effluent/process streams/waste streams comprising fluorine species. As such, a method is provided for removing fluorine from a process stream or waste stream comprising fluorine (e.g., in the form of one or more fluorine containing species) in a solvent, the method comprising contacting the process stream or waste stream with a glass adsorbent (e.g., a barium silicate glass) to adsorb the fluorine (e.g., by physical adsorption or chemical reaction). In this case, the process/waste stream comprising fluorine species in a solvent may be formed by extracting the fluorine species into the solvent from a solid phase material comprising fluorine (e.g., in the form of one or more fluorine containing compounds).

As used herein, the term “comprising” means “including”. Variations of the word “comprising”, such as “comprise” and “comprises”, have correspondingly varied meanings. As used herein, the terms “including” and “comprising” are non-exclusive. As used herein, the terms “including” and “comprising” do not imply that the specified integer(s) represent a major part of the whole.

Where applicants have defined an invention or a portion thereof with an open-ended term such as “comprising”, it should be readily understood that (unless otherwise stated) the description should be interpreted to also describe such an invention using the terms “consisting essentially of” or “consisting of”. In other words, with respect to the terms “comprising”, “consisting of”, and “consisting essentially of”, where one of these three terms are used herein, the presently disclosed and claimed subject matter may include the use of either of the other two terms. Thus, in some embodiments not otherwise explicitly recited, any instance of “comprising” may be replaced by “consisting of” or, alternatively, by “consisting essentially of”.

The transitional phrase “consisting of” excludes any element, step, or ingredient not specified. If in the claim, such would close the claim to the inclusion of materials other than those recited except for impurities ordinarily associated therewith. When the phrase “consisting of” appears in a clause of the body of a claim, rather than immediately following the preamble, it limits only the element set forth in that clause; other elements are not excluded from the claim as a whole.

The transitional phrase “consisting essentially of” is used to define a composition, process or method that includes materials, steps, features, components, or elements, in addition to those literally disclosed, provided that these additional materials, steps, features, components, or elements do not materially affect the basic and novel characteristic(s) of the claimed invention. The term “consisting essentially of” occupies a middle ground between “comprising” and “consisting of”.

Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Also, the indefinite articles “a” and “an” preceding an element or component of the invention are intended to be non-restrictive regarding the number of instances (i.e., occurrences) of the element or component. Therefore “a” or “an” should be read to include one or at least one, and the singular word form of the element or component also includes the plural unless the number is obviously meant to be singular.

Other than in the operating examples, or where otherwise indicated, all numbers expressing quantities of ingredients or reaction conditions used herein are to be understood as modified in all instances by the term “about”. The examples are not intended to limit the scope of the invention. Where otherwise indicated herein, “%” or “wt %” will mean “weight %”.

The terms “predominantly” and “substantially” as used herein shall mean comprising more than 50% by weight, unless otherwise defined.

As used herein, with reference to numbers in a range of numerals, the terms “about”, “approximately” and “substantially” are understood to refer to the range of −10% to +10% of the referenced number, preferably −5% to +5% of the referenced number, more preferably −1% to +1% of the referenced number, most preferably −0.1% to +0.1% of the referenced number, unless otherwise defined. Moreover, with reference to numerical ranges, these terms should be construed as providing support for a claim directed to any number or subset of numbers in that range. For example, a disclosure of from 1 to 10 should be construed as supporting a range of from 1 to 8, from 3 to 7, from 1 to 9, from 3.6 to 4.6, from 3.5 to 9.9, from 8 to 10, and so forth.

As used herein, wt. % refers to the weight of a particular component relative to total weight of the referenced composition.

The complete disclosures of the patents, patent documents and publications cited herein are incorporated by reference in their entirety as if each were individually incorporated.

Forms of the present invention include:

1. A method of recycling one or more valuable metal elements from a solid source material comprising the one or more valuable metal elements and fluorine, the method comprising:
forming an acidic aqueous recycling feed by acid leaching the source material, or derivative thereof, the acidic aqueous recycling feed comprising the one or more valuable metal elements; and
recovering the one or more valuable metal elements from the acidic aqueous recycling feed via one or more further process steps selected from solvent extraction, solid phase extraction, electrochemical extraction, and precipitation processes,
wherein the fluorine is extracted prior to recovery of the one or more valuable metal elements from the acidic aqueous recycling feed by one or more of the following processes:
   (a) leaching the source material, or a derivative thereof, with a solvent to remove fluorine from the source material into the solvent prior to forming the acidic aqueous recycling feed, adsorbing the fluorine in the solvent onto an adsorbent, and recycling the solvent to perform further leaching of fluorine from source material;
   (b) leaching the source material, or a derivative thereof, with a solvent to remove at least one of the valuable metal elements from the source material into the solvent prior to forming the acidic aqueous recycling feed, adsorbing fluorine in the solvent onto an adsorbent, and further processing the solvent to recover said at least one of the valuable metal elements; and
   (c) after forming the acidic aqueous recycling feed, adsorbing fluorine in the acidic aqueous recycling onto an adsorbent prior to recovering the one or more valuable metal elements from the acidic aqueous recycling feed.

2. A method according to form 1, wherein the solvent used in option (a) comprises one or more of an aqueous solvent, an acidic solvent, a basic solvent, and an organic solvent.

3. A method according to form 1 or 2, wherein the adsorbent is one or more of a silica-based adsorbent, a metal-based adsorbent, a solid phase support media functionalized with a basic anion exchange group, and a solid phase support media functionalised with a chelating ligand which is optionally pre-loaded with metal ions.

4. A method according to any preceding form, wherein the adsorbent is a glass material.

5. A method according to any preceding form, wherein the adsorbent is a barium-silicate glass material.

6. A method according to any preceding form, wherein the adsorbent is in the form of a glass powder.

7. A method according to any preceding form, wherein the source material is in the form of a powder.

8. A method according to form 7, wherein the powder has a maximum particle size of less than 1 mm.

9. A method according to any preceding form, wherein the source material is a waste battery material, or wherein the source material is a waste material comprising one or more platinum group metals.

10. A method according to any preceding form, wherein the source material is a waste battery cathode material comprising lithium and at least one of nickel, cobalt and/or manganese.

11. A method according to form 10, wherein lithium is leached into the solvent from the source material in option (b) and the fluorine is adsorbed from the lithium containing solvent prior to further processing to recover the lithium.

12. A method according to form 11, wherein said solvent in option (b) is an organic acid.

13. A method according to any preceding form, wherein the solvent in option (b) is recycled and reused in the method after adsorption of the fluorine and recovery of said at least one valuable metal element.

14. A method according to any preceding form, wherein the acidic aqueous recycling feed is formed using a mineral acid, optionally sulphuric acid or hydrochloric acid.

15. A method according to any preceding form, wherein the acidic aqueous recycling feed contains substantially no fluorine at least during the processing steps for recovering the one or more valuable metal elements from the acidic aqueous recycling feed.

16. A method according to any preceding form, wherein after processing of the acidic aqueous recycling feed to recover the one or more valuable metal elements from the acidic aqueous recycling feed, the acid of the acidic aqueous recycling feed is recycled and reused in the method.

17. A method for removing fluorine from a process or waste stream comprising fluorine in a solvent, the method comprising contacting the process or waste stream with a glass adsorbent to adsorb the fluorine.

18. A method according to form 17, wherein the process or waste stream is formed by extracting the fluorine species into the solvent from a solid phase material, optionally a battery waste material, comprising fluorine.

19. A method according to form 17 or 18, wherein the glass adsorbent comprises a barium-silicate glass.

While this invention has been particularly shown and described with reference to certain examples, it will be understood to those skilled in the art that various changes in form and detail may be made without departing from the scope of the invention as defined by the appended claims.

1. A method of recycling one or more valuable metal elements from a solid source material comprising the one or more valuable metal elements and fluorine, the method comprising:
forming an acidic aqueous recycling feed by acid leaching the source material, or derivative thereof, the acidic aqueous recycling feed comprising the one or more valuable metal elements; and
recovering the one or more valuable metal elements from the acidic aqueous recycling feed via one or more further process steps selected from solvent extraction, solid phase extraction, electrochemical extraction, and precipitation processes,
wherein the fluorine is extracted prior to recovery of the one or more valuable metal elements from the acidic aqueous recycling feed by one or more of the following processes:
a. leaching the source material, or a derivative thereof, with a solvent to remove fluorine from the source material into the solvent prior to forming the acidic aqueous recycling feed, adsorbing the fluorine in the solvent onto an adsorbent, and recycling the solvent to perform further leaching of fluorine from source material;
b. leaching the source material, or a derivative thereof, with a solvent to remove at least one of the valuable metal elements from the source material into the solvent prior to forming the acidic aqueous recycling feed, adsorbing fluorine in the solvent onto an adsorbent, and further processing the solvent to recover said at least one of the valuable metal elements; and
c. after forming the acidic aqueous recycling feed, adsorbing fluorine in the acidic aqueous recycling onto an adsorbent prior to recovering the one or more valuable metal elements from the acidic aqueous recycling feed.

2. A method according to claim 1,
wherein the solvent used in option (a) comprises one or more of an aqueous solvent, an acidic solvent, a basic solvent, and an organic solvent.

3. A method according to claim 1 or 2,
wherein the adsorbent is one or more of a silica-based adsorbent, a metal-based adsorbent, a solid phase support media functionalized with a basic anion exchange group, and a solid phase support media functionalised with a chelating ligand which is optionally pre-loaded with metal ions.

4. A method according to any one of the preceding claims, wherein the adsorbent is a glass material.

5. A method according to any one of the preceding claims,
wherein the adsorbent is a barium-silicate glass material.

6. A method according to any one of the preceding claims,
wherein the adsorbent is in the form of a glass powder.

7. A method according to any one of the preceding claims,
wherein the source material is in the form of a powder.

8. A method according to claim 7, wherein the powder has a maximum particle size of less than 1 mm.

9. A method according to any one of the preceding claims,
wherein the source material is a waste battery material, or
wherein the source material is a waste material comprising one or more platinum group metals.

10. A method according to any one of the preceding claims,
wherein the source material is a waste battery cathode material comprising lithium and at least one of nickel, cobalt and/or manganese.

11. A method according to claim 10,
wherein lithium is leached into the solvent from the source material in option (b) and the fluorine is adsorbed from the lithium containing solvent prior to further processing to recover the lithium.

12. A method according to claim 11,
wherein said solvent in option (b) is an organic acid.

13. A method according to any one of the preceding claims, wherein the solvent in option (b) is recycled and reused in the method after adsorption of the fluorine and recovery of said at least one valuable metal element.

14. A method according to any one of the preceding claims, wherein the acidic aqueous recycling feed is formed using a mineral acid, optionally sulphuric acid or hydrochloric acid.

15. A method according to any one of the preceding claims, wherein the acidic aqueous recycling feed contains substantially no fluorine at least during the processing steps for recovering the one or more valuable metal elements from the acidic aqueous recycling feed.

16. A method according to any one of the preceding claims, wherein after processing of the acidic aqueous recycling feed to recover the one or more valuable metal elements from the acidic aqueous recycling feed, the acid of the acidic aqueous recycling feed is recycled and reused in the method.

17. A method for removing fluorine from a process or waste stream comprising fluorine in a solvent, the method comprising contacting the process or waste stream with a glass adsorbent to adsorb the fluorine.

18. A method according to claim 17, wherein the process or waste stream is formed by extracting the fluorine species into the solvent from a solid phase material, optionally a battery waste material, comprising fluorine.

19. A method according to claim 17 or 18, wherein the glass adsorbent comprises a barium-silicate glass.
